(19) United States
(12) Patent Application Publication
(10) Pub. No.: US 2023/0170136 A1
(43) Pub. Date: Jun. 1, 2023

(54) MAGNETIC ASSEMBLY, MANUFACTURING METHOD THEREOF, POWER MODULE AND SWITCHING POWER SUPPLY

(71) Applicant: Aplus Power Technology (Hangzhou) Co., Ltd., Zhejiang Province (CN)

(72) Inventor: Yuetian WANG, Zhejiang Province (CN)

(21) Appl. No.: 18/072,493

(22) Filed: Nov. 30, 2022

(30) Foreign Application Priority Data
Nov. 30, 2021 (CN) 202111450931.8

(51) Int. Cl. H01F 27/30; H01F 27/38; H01F 27/08

(52) U.S. Cl. CPC H01F 27/306; H01F 27/38; H01F 27/085

(57) ABSTRACT

The present application provides a magnetic assembly, a manufacturing method thereof, a power module and a switching power supply. The magnetic assembly comprises at least two X-type magnetic cores and at least one I-type magnetic core; a winding is arranged on the X-type magnetic core, and the at least two X-type magnetic cores and the at least one I-type magnetic core form a closed magnetic circuit; the X-type magnetic core includes a winding post and four side posts surrounding the winding post, and one side of each of the four side posts is respectively connected with one side of the winding post to form a connection surface; the other sides of the four side posts and the winding post are respectively arranged in contact with the connection surface of the I-type magnetic core or other X-type magnetic cores. The application can solve the problem of poor heat dissipation after integration of a plurality of magnetic elements.

### CROSS REFERENCE TO RELATED APPLICATIONS

This application claims priority to Chinese Application Number 202111450931.8, filed on Nov. 30, 2021, the subject matter of which is incorporated herein by reference.

### TECHNICAL FIELD

The present application relates to the technical field of a magnetic assembly, in particular to a magnetic assembly, a manufacturing method thereof, a power module and a switching power supply.

### BACKGROUND

At present, most servers and communication power supplies are provided with switching power supplies. In order to improve operating frequency, power density and automatic manufacturability of the switching power supply, and at the same time to reduce the manufacturing cost, more and more switching power supplies are designed in a modular way. Modularization refers to that a power semiconductor device of the switching power supply is arranged on a module circuit board, and then the module circuit board is arranged on a main circuit board, wherein the module circuit board is further provided with a magnetic element and a power conversion line.

Since the height of most servers and communication power supplies needs to be designed to be 1 U, the height of the module circuit board disposed inside the servers and communication power supplies is limited. Since the magnetic element occupies considerable volume, weight and loss on the module circuit board, the design and spatial layout of the magnetic element can determine the utilization rate of the module circuit board (PCB) and the overall performance of the communication power supply. At present, in order to reduce the size of the magnetic element and improve the utilization rate of the module circuit board, generally a magnetic element of a planar structure is formed in a manner in which a plurality of magnetic elements are integrated.

### SUMMARY OF THE INVENTION

It is an object of the present application to provide a magnetic assembly to solve the problem of poor heat dissipation after integration of a plurality of magnetic elements. It is another object of the present application to provide a power module. It is a further object of the present application to provide a switching power supply. It is still another object of the present application to provide a method of fabricating a magnetic assembly.

In order to achieve the above objects, an aspect of the present application discloses a magnetic assembly comprising at least two X-type magnetic cores and at least one I-type magnetic core.

A winding is arranged on the X-type magnetic core, and the at least two X-type magnetic cores and the at least one I-type magnetic core form a closed magnetic circuit.

The X-type magnetic core includes a winding post and four side posts surrounding the winding post, and one side of each of the four side posts is respectively connected with one side of the winding post to form a connection surface.

The other sides of the four side posts and the winding post are respectively arranged in contact with the connection surface of the I-type magnetic core or other X-type magnetic cores.

Alternatively, the magnetic assembly comprises a two-way magnetic assembly which includes two X-type magnetic cores and one I-type magnetic core, the two X-type magnetic cores including a first magnetic core and a second magnetic core, and the one I-type magnetic core being a third magnetic core.

The first magnetic core and the second magnetic core are provided with a first winding and a second winding, respectively.

The first magnetic core, the second magnetic core, and the third magnetic core are sequentially arranged in an order of the first magnetic core, the third magnetic core, and the second magnetic core, or in an order of the first magnetic core, the second magnetic core, and the third magnetic core.

Alternatively, the winding posts of the first magnetic core and/or the second magnetic core are formed with air gaps.

Alternatively, the air gap consists of a plurality of air gaps.

Alternatively, the winding posts of the first magnetic core and the second magnetic core are formed with a first air gap and a second air gap, respectively, and the first air gap and the second air gap are equal in size.

Alternatively, when direct current is input to the first winding and the second winding respectively, the direct current magnetic fluxes formed in the winding post of the first magnetic core and the winding post of the second magnetic core have the same direction.

When alternating current is input to the first winding and the second winding respectively, the alternating current magnetic fluxes formed in the winding post of the first magnetic core and the winding post of the second magnetic core have the same direction and the phases between them differ by 180 degrees.

Alternatively, the two-way magnetic assembly is a two-way inductor, the first winding includes a first coil, and the second winding includes a second coil.

Alternatively, the two-way magnetic assembly comprises an inductor and a transformer, the first winding includes an inductive coil of the inductor and the second winding includes a primary side coil and a secondary side coil of the transformer.

Alternatively, the magnetic assembly comprises a three-way magnetic assembly which includes three X-type magnetic cores and one I-type magnetic core, the three X-type magnetic cores including a fourth magnetic core, a fifth magnetic core and a sixth magnetic core, and the one I-type magnetic core being a seventh magnetic core.

The fourth magnetic core, the fifth magnetic core and the sixth magnetic core are provided with a fourth winding, a fifth winding and a sixth winding, respectively.

The fourth magnetic core, the fifth magnetic core, the sixth magnetic core and the seventh magnetic core are sequentially arranged in an order of the fourth magnetic core, the fifth magnetic core, the sixth magnetic core and the seventh magnetic core, or in an order of the fourth magnetic core, the seventh magnetic core, the fifth magnetic core and the sixth magnetic core.

Alternatively, the winding post of at least one of the fourth magnetic core, the fifth magnetic core and the sixth magnetic core is formed with an air gap.

Alternatively, the winding posts of the fourth magnetic core, the fifth magnetic core and the sixth magnetic core are formed with a fourth air gap, a fifth air gap and a sixth air gap, respectively, and the fourth air gap, the fifth air gap and the sixth air gap are equal in size.

Alternatively, when direct current is input to the fourth winding, the fifth winding and the sixth winding respectively, the direct current magnetic fluxes formed in the winding posts of the fourth magnetic core, the fifth magnetic core and the sixth magnetic core have the same direction.

When alternating current is input to the fourth winding, the fifth winding and the sixth winding respectively, the alternating current magnetic fluxes formed in the winding posts of the fourth magnetic core, the fifth magnetic core and the sixth magnetic core have the same direction and the phases between them differ by 120 degrees.

Alternatively, the three-way magnetic assembly is a three-way inductor, the fourth winding includes a fourth coil, the fifth winding includes a fifth coil, and the sixth winding includes a sixth coil.

Alternatively, the three-way magnetic assembly is a three-phase inductor, the fourth winding includes a seventh coil, the fifth winding includes an eighth coil, and the sixth winding includes a ninth coil.

Alternatively, the three-way magnetic assembly is a three-phase transformer, the fourth winding includes a first primary side coil and a first secondary side coil, and the fifth winding includes a second primary side coil and a second secondary side coil, and the sixth winding includes a third primary side coil and a third secondary side coil.

The present application further discloses a power module comprising a magnetic assembly as described above.

The present application further discloses a switching power supply comprising a power module as described above.

The magnetic assembly of the present application comprises at least two X-type magnetic cores and at least one I-type magnetic core. The two X-type magnetic cores and the at least one I-type magnetic core provide a closed magnetic circuit. Wherein the X-type magnetic core includes a winding post and four side posts surrounding the winding post, and one side of each of the four side posts is respectively connected with one side of the winding post to form a connection surface. Thus, the two adjacent side posts of the X-type magnetic core are hollowed out to form a strip-shaped gap, which can provide a heat dissipation channel along an extending direction of the side posts for the magnetic assembly. Since the X-type magnetic core includes four side posts, four heat dissipation channels along the first direction in which the side posts extend can be provided for the magnetic assembly, increasing the heat dissipation area. In addition, since an annular gap exists between the winding post and the side post of each X-type magnetic core, the annular gap communicates with the strip-shaped gap between two adjacent side posts, and jointly forming an annular heat dissipation channel in a second direction perpendicular to the extending direction of the side posts. Therefore, the magnetic assembly of the present application has two main heat dissipation channels, which can better take away the heat generated inside the magnetic assembly and improve the heat dissipation effect, which solves the problem of poor heat dissipation after integration of a plurality of magnetic elements, and improves the service life and use safety of the magnetic assembly.

### BRIEF DESCRIPTION OF THE DRAWINGS

To illustrate more clearly the embodiments of the present application or the technical schemes of the prior art, a brief description of the accompanying drawings in the embodiments or the prior art will be given below. Obviously, the accompanying drawings described below are only some embodiments described in this application. For those of ordinary skill in the art, other drawings can also be obtained without any creative labor from these drawings.

FIG. 1 is a schematic diagram of a specific embodiment of a two-way magnetic assembly of the magnetic assembly in the present application;

FIG. 2 is a schematic diagram of the interior of the first magnetic core or second magnetic core for a specific embodiment of the two-way magnetic assembly of the magnetic assembly in the present application;

FIG. 3 is a schematic diagram of the first magnetic core, the second magnetic core and the third magnetic core for a specific embodiment of the two-way magnetic assembly of the magnetic assembly in the present application;

FIG. 4 is an exploded view of a specific embodiment of a two-way magnetic assembly of the magnetic assembly in the present application;

FIG. 5 is an equivalent circuit topology diagram of a specific embodiment of a two-way magnetic assembly of the magnetic assembly in the present application;

FIG. 6 is a schematic diagram of another specific embodiment of a two-way magnetic assembly of the magnetic assembly in the present application;

FIGS. 7 to 11 show circuit topology diagrams in various circuits for applications of the magnetic assembly in the present application;

FIG. 12 is a schematic diagram of a specific embodiment of a three-way magnetic assembly of the magnetic assembly in the present application.

### REFERENCE NUMERALS

11. first magnetic core; 12. second magnetic core; 13. third magnetic core; 101. winding post; 102. side post; 103. connection surface; 114. first winding; 124. second winding; 14. fourth magnetic core; 15. fifth magnetic core; 16. sixth magnetic core; 17. seventh magnetic core.

### DETAILED DESCRIPTION OF THE PREFERRED EMBODIMENTS

Hereinafter the technical solution in the embodiments of the present application will be described clearly and integrally in combination with the accompanying drawings in the embodiments of the present application, and obviously the described embodiments are merely part of the embodiments, not all of the embodiments. Any other embodiment obtained by those skilled in the art based on the embodiments of the present application without paying any creative labor fall within the protection scope of the present application.

It should be noted that the terms “first,” “second” and the like in the description and claims of the present application and in the above-mentioned drawings are used to distinguish between similar objects and are not necessarily used to describe a particular order or precedence. It should be understood that the data so used may be interchanged where appropriate for the purpose of the embodiments of the present application described herein. Furthermore, the terms “comprising” and “having” and any variations thereof are intended to cover non-exclusive inclusions, such as, for example, a process, a method, a system, a product or a device comprising a series of steps or units need not to be limited to those steps or units that are clearly listed, but may include other steps or units that are not explicitly listed or inherent to these processes, methods, products or devices.

In the present application, the orientation or positional relationship indicated by the terms “on”, “under”, “left”, “right”, “front”, “back”, “top”, “bottom”, “inside”, “outside”, “middle”, “vertical”, “horizontal”, “transverse”, “longitudinal” and the like is based on the orientation or positional relationship shown in the drawings. These terms are mainly intended to better describe the present application and its embodiments and are not intended to limit that the indicated devices, elements or constituents must have a particular orientation, or be constructed and operated in a particular orientation.

The positional relationship such as “parallel” or “vertical” includes not only the positional relationship of exactly “parallel” or “vertical,” but also the positional relationship that the angle deviation relative to exactly “parallel” or “vertical” is within the preset deviation range.

Also, in addition to being used to represent an orientation or positional relationship, some of the above terms may also be used to indicate other meanings. For example, the term “on” may also be used in some cases to denote a certain attachment or connection. The specific meanings of these terms in the present application may be understood by those ordinarily skilled in the art as the case may be.

In addition, the terms “installation”, “setting”, “being provided with”, “connecting”, “connected”, “sleeving” should be understood broadly. For example, the connection may be a fixed connection, a detachable connection or an integrated construction, or may be a mechanical connection or an electrical connection, or may be a direct connection, or may be an indirect connection through an intermediary, or an internal communication between two devices, elements or constituents. The specific meanings of the above terms in the present application may be understood by those ordinarily skilled in the art as the case may be.

It should be noted that the embodiments in the present application and the features in the embodiments can be combined with each other without conflict. Hereinafter, the present application will be described in detail with reference to the drawings and in connection with embodiments.

In the prior art, the switching power supply usually adopts a modular design, in which a power semiconductor device is arranged on a module circuit board, the module circuit board is further provided with a magnetic element and a power conversion line, then the module circuit board is arranged on the main circuit board, to form the switching power supply.

The server and communication power supply usually need to be arranged on the cabinet, and the height of each layer in the cabinet is usually 1 U, therefore, the height of the server and the communication power supply and other equipment need to be set below 1 U, the switching power supplies used in the server and the communication power supplies are limited by the height of the server and communication power supplies. The magnetic element occupies considerable volume, weight and loss on the module circuit board, thus it is necessary to reduce the size of the magnetic element on the module circuit board as much as possible and improve the utilization rate of the module circuit board.

In recent years, the design and spatial layout of the magnetic element have undergone rapid development. The structure of the magnetic element has developed from a single independent winding type to various forms such as a planar structure, a matrix structure, a module structure, an integrated structure and a mixed structure and the like. Under the development trend of modularization of the communication power supply and high frequency of switching frequency, the magnetic element of the planar structure has the advantages of small volume and high power density, and thus are widely used in the design of the magnetic element of the module circuit board. However, a magnetic element of a planar structure that is formed by integrating a plurality of magnetic elements and the existing magnetic element are made of ferrite material, which results in a problem that the heat dissipation effect of the magnetic element is poor, and affects service life and use safety of the magnetic element. Based on the problems in the prior art, the embodiment of the present application provides a magnetic assembly, which increases the heat dissipation area of the magnetic assembly, provides two different heat dissipation directions, and thus improves the heat dissipation effect, better takes away the heat generated inside the magnetic assembly, solves the problem of poor heat dissipation after integration of a plurality of magnetic elements, and improves the service life and use safety of the magnetic assembly.

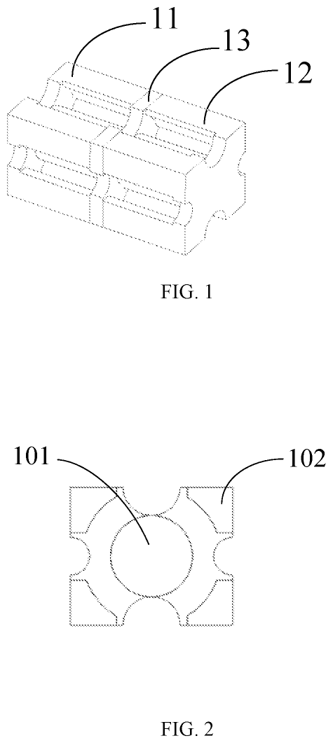

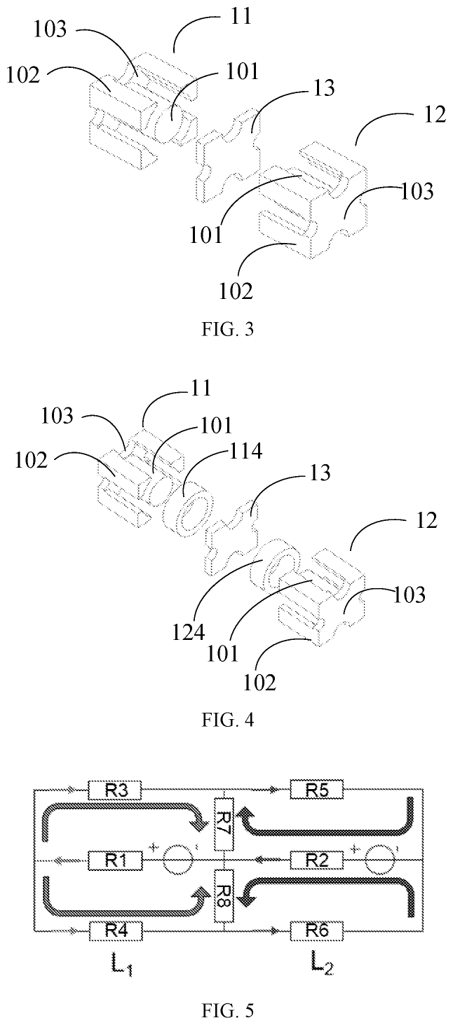

Based on this, according to an aspect of the present application, the present embodiment discloses a magnetic assembly. As shown in FIGS. 1 to 6 and 12, the magnetic assembly includes at least two X-type magnetic cores and at least one I-type magnetic core.

Wherein a winding is arranged on the X-type magnetic core, and the at least two X-type magnetic cores and the at least one I-type magnetic core form a closed magnetic circuit.

The X-type magnetic core includes a winding post 101 and four side posts 102 surrounding the winding post 101, and one side of each of the four side posts 102 is respectively connected with one side of the winding post 101 to form a connection surface 103.

The other sides of the four side posts 102 and the winding post 101 are respectively arranged in contact with the connection surface 103 of the I-type magnetic core or other X-type magnetic cores.

The magnetic assembly of the present application comprises at least two X-type magnetic cores and at least one I-type magnetic core. The two X-type magnetic cores and the at least one I-type magnetic core provide a closed magnetic circuit. Wherein, the X-type magnetic core includes a winding post 101 and four side posts 102 surrounding the winding post 101, and one side of each of the four side posts 102 is respectively connected with one side of the winding post 101 to form a connection surface 103. Thus, the two adjacent side posts 102 of the X-type magnetic core are hollowed out to form a strip-shaped gap, which can provide a heat dissipation channel along an extending direction of the side posts 102 for the magnetic assembly. Since the X-type magnetic core includes four side posts 102, four heat dissipation channels along the first direction in which the side posts 102 extend can be provided for the magnetic assembly, increasing the heat dissipation area. In addition, since an annular gap exists between the winding post 101 and the side post 102 of each X-type magnetic core, the annular gap communicates with the strip-shaped gap between two adjacent side posts 102, and jointly forming an annular heat dissipation channel in a second direction perpendicular to the extending direction of the side posts 102. Therefore, the magnetic assembly of the present application has two main heat dissipation channels, which can better take away the heat generated inside the magnetic assembly and improve the heat dissipation effect, which solves the problem of poor heat dissipation after integration of a plurality of magnetic elements, and improves the service life and use safety of the magnetic assembly.

In an alternative embodiment, as shown in FIGS. 1 to 4, the magnetic assembly comprises a two-way magnetic assembly. The two-way magnetic assembly includes two X-type magnetic cores and one I-type magnetic core, the two X-type magnetic cores includes a first magnetic core 11 and a second magnetic core 12, and the one I-type magnetic core is a third magnetic core 13.

Wherein, the first magnetic core 11 and the second magnetic core 12 are provided with a first winding 114 and a second winding 124, respectively. The first magnetic core 11, the second magnetic core 12, and the third magnetic core 13 are sequentially arranged in an order of the first magnetic core 11, the third magnetic core 13, and the second magnetic core 12, or in an order of the first magnetic core 11, the second magnetic core 12, and the third magnetic core 13.

In one or more specific embodiments, the first magnetic core 11, the second magnetic core 12, and the third magnetic core 13 are sequentially arranged in an order of the first magnetic core 11, the third magnetic core 13, and the second magnetic core 12. FIG. 5 shows an equivalent circuit topology diagram of the specific example, in FIG. 5, R1 denotes the equivalent resistance of the winding post 101 of the first magnetic core, R2 denotes the equivalent resistance of the winding post 101 of the second magnetic core, R3 and R4 denote the equivalent resistance of the side post 102 of the first magnetic core, R5 and R6 denote the equivalent resistance of the side post 102 of the second magnetic core, and R7 and R8 denote the equivalent resistance of the third magnetic core 13. The arrow 1 indicates the direction of transmission of the induced current formed in the winding post 101 of the first magnetic core, the arrow 2 indicates the direction of the magnetic field in the closed magnetic circuit formed by the first magnetic core 11 and the third magnetic core 13, the arrow 3 indicates the direction of transmission of the induced current formed in the winding post 101 of the second magnetic core, and the arrow 4 indicates the direction of the magnetic field in the closed magnetic circuit formed by the second magnetic core 12 and the third magnetic core 13. As can be seen from FIG. 5, the magnetic flux in the closed magnetic circuit of the first magnetic core 11 and the second magnetic core 12 is partially canceled at the third magnetic core 13, and the partial cancellation of the magnetic flux can reduce the loss of the third magnetic core 13. Furthermore, on this basis, in the case where the loss of the third magnetic core 13 is reduced, the thickness of the third magnetic core 13 can be further reduced, so that the present application can use the third magnetic core 13 with a smaller size to form a closed magnetic circuit, reducing the volume of the magnetic assembly. Moreover, the first magnetic core 11 and the second magnetic core 12 include four side posts 102, so that the magnetic flux in the magnetic assembly is more dispersed, and the loss of the magnetic core can be reduced.

As can be seen from FIGS. 1 to 4, two adjacent side posts 102 of the four side posts 102 of the first magnetic core 11 and the second magnetic core 12 form a strip-shaped gap, which can provide a heat dissipation channel along an extending direction of the side posts 102 for the magnetic assembly. The first magnetic core 11 and the second magnetic core 12 both include four side posts 102, thus four heat dissipation channels along the first direction in which the side posts 102 extend can be provided for the magnetic core, increasing the heat dissipation area. In addition, an annular gap exists between the winding post 101 and the side post 102 of the first magnetic core 11 and the second magnetic core, the annular gap communicates with the strip-shaped gap between two adjacent side posts 102, and jointly forming an annular heat dissipation channel in a second direction perpendicular to the extending direction of the side posts 102. Therefore, in this embodiment, the magnetic assembly has two main heat dissipation channels in a first direction and a second direction, which can better take away the heat generated inside the magnetic assembly and improve the heat dissipation effect, which solves the problem of poor heat dissipation after integration of a plurality of magnetic elements, and improves the service life and use safety of the magnetic assembly.

As an alternative embodiment, the side posts 102 of the first magnetic core 11 and the second magnetic core may be arranged correspondingly, that is, on the same straight line. That is, four strip-shaped gaps of the first magnetic core 11 respectively correspond to the strip-shaped gaps of the second magnetic core 12, and communicate with the first direction heat dissipation channel of the first magnetic core 11 and the second magnetic core 12, so as to ensure smooth airflow and improve the heat dissipation effect.

As an alternative embodiment, the surfaces of the first magnetic core 11 and the second magnetic core 12 at the strip-shaped gaps are recessed inward to form grooves, so as to increase the flow area of the heat dissipation airflow and improve the heat dissipation effect.

As an alternative embodiment, the edge of the strip-shaped gap of the third magnetic core 13 corresponding to the first magnetic core 11 and the second magnetic core 12 may also be recessed inward to form a groove, so as to prevent the third magnetic core 13 from blocking the airflow, to ensure smooth airflow and improve the heat dissipation effect.

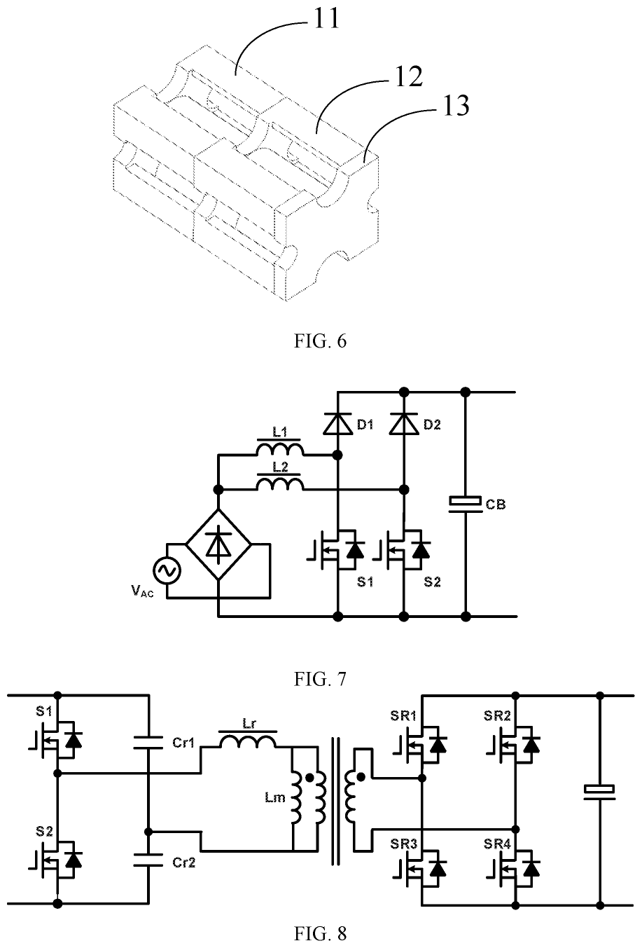

Of course, in other embodiments, the first magnetic core 11, the second magnetic core 12 and the third magnetic core 13 may also be sequentially arranged in an order of the first magnetic core 11, the second magnetic core 12 and the third magnetic core 13, as shown in FIG. 6. In this embodiment, the connection surface 103 of the first magnetic core faces the outside of the magnetic assembly. That is, the connection surface 103 of the first magnetic core is located on a side of the first magnetic core 11 facing away from the second magnetic core 12, and the unconnected ends of the four side posts 102 of the first magnetic core 11 are arranged in contact with the connection surface 103 of the second magnetic core, thus the first magnetic core 11 and the connection surface 103 of the second magnetic core form a closed magnetic circuit. The unconnected ends of the four side posts 102 of the second magnetic core 12 are arranged in contact with the third magnetic core 13, thus the second magnetic core 12 and the third magnetic core 13 form a closed magnetic circuit.

It should be noted that in this embodiment, the first magnetic core 11, the second magnetic core 12 and the third magnetic core 13 are arranged in this order from left to right, wherein the directions of “left” and “right” are relative, the technical solution corresponding to the embodiment in which the first magnetic core 11, the second magnetic core 12 and the third magnetic core 13 are arranged in this order from right to left should also be within the scope of protection of the present application.

In addition, the first magnetic core 11 and the second magnetic core 12 are both X-type magnetic cores, and the first magnetic core 11 and the second magnetic core 12 are illustrated as examples only, and the positions of the X-type magnetic cores of the first magnetic core 11 and the second magnetic core 12 may also be interchanged. That is, in this embodiment, the first magnetic core 11, the second magnetic core 12 and the third magnetic core 13 are sequentially arranged in this order, and in other embodiments, may also be sequentially arranged in an order of the second magnetic core 12, the first magnetic core 11 and the third magnetic core 13, and the technical solution corresponding to this embodiment is also supposed to be within the protection scope of the present application.

In an alternative embodiment, the first winding 114 and the second winding 124 have the same number of turns.

It can be understood that the first winding 114 and the second winding 124 may have the same number of turns in order to make the two-way magnetic assembly have the same two-way magnetic performance, for example, to obtain two inductors having the same inductance value. Of course, in practical applications, those skilled in the art may determine the number of turns of the first winding 114 and the second winding 124 according to practical requirements, which is not limited by the present application.

In an alternative embodiment, the winding posts 101 of the first magnetic core 11 and/or the second magnetic core are formed with air gaps. Alternatively, the air gap consists of a plurality of air gaps.

It is to be understood that one or more segments of air gap may be formed on the winding posts of the first magnetic core 11 and/or the second magnetic core in order to avoid magnetic saturation and other undesirable phenomena. Of course, those skilled in the art can determine whether or not to provide one or more segments of air gap on the first magnetic core 11 and the second magnetic core 12 according to actual needs, and this application is not limited to these.

In an alternative embodiment, the winding posts 101 of the first magnetic core 11 and the second magnetic core are formed with a first air gap and a second air gap, respectively, and the first air gap and the second air gap are equal in size.

It can be understood that, when it is necessary to form a first air gap and a second air gap on the winding posts 101 of the first magnetic core 11 and the second magnetic core, respectively, in order to make the magnetic properties of the first magnetic core 11 and the second magnetic core 12 as identical as possible, alternatively the first air gap and the second air gap are set equal in size.

In an alternative embodiment, when direct current is input to the first winding 114 and the second winding 124 respectively, the direct current magnetic fluxes formed in the winding post 101 of the first magnetic core and the winding post 101 of the second magnetic core have the same direction.

When alternating current is input to the first winding 114 and the second winding 124 respectively, the alternating current magnetic fluxes formed in the winding post 101 of the first magnetic core and the winding post 101 of the second magnetic core have the same direction and the phases between them differ by 180 degrees.

In particular, in order to achieve at least partial cancellation of the magnetic fluxes of the first magnetic core 11 and the second magnetic core 12 that are formed on the third magnetic core 13 and in consideration of the difference between circuit structures applied by the two-way magnetic assembly, when current is input to the first winding 114 on the first magnetic core 11 and the second winding 124 on the second magnetic core 12, respectively, it is necessary to ensure that the magnetic fluxes formed by the direct current have the same direction, and the magnetic fluxes formed by the alternating current have the same direction, and the phases between them differ by 180 degrees.

In a specific embodiment, the two-way magnetic assembly is a two-way inductor, the first winding 114 includes a first coil, and the second winding 124 includes a second coil. That is, the two-way magnetic assembly can be used to make a magnetic assembly integrated by two inductors. For example, an interleaved two-way interleaved PFC (Power Factor Correction) inductor may be formed for use in a two-way interleaved PFC circuit. As shown in FIG. 7, the two-way interleaved PFC circuit is a common technique in the field, and is not described herein.

FIGS. 7 to 11 show circuit topology diagrams in various circuits for applications of the magnetic assembly. In FIGS. 7 to 11, L1, L2, Lr, Lr1, Lr2, Lr3, Lm and L3 denote inductors, D1, D2 and D3 denote diodes, S1, S2, S3, S4, S5, S6, SR1, SR2, SR3 and SR4 denote switching elements, C, C1, C2, C3, CB, Cr1 and Cr2 denote capacitors, V_{AC}, V_{A}, V_{B}, V_{C} and Vᵢₙ denote power supplies, R denotes a resistor, Tx1, Tx2 and Tx3 denote transformers.

Specifically, a first coil may be wound around the first magnetic core 11 as the first winding 114, a second coil may be wound around the second magnetic core 12 as the second winding 124, and then the first magnetic core 11, the second magnetic core 12, and the third magnetic core 13 may be combined so that a closed magnetic circuit may be formed in the first magnetic core 11, the second magnetic core 12, and the third magnetic core 13 to obtain a two-way inductor.

In another specific embodiment, the two-way magnetic assembly comprises an inductor and a transformer. The first winding 114 includes an inductive coil of the inductor and the second winding 124 includes a primary side coil and a secondary side coil of the transformer. That is, the two-way magnetic assembly can be used to make a magnetic assembly integrated by the inductors and the transformers, for use in the switching power supply, as shown in FIG. 8.

Specifically, an inductor coil may be wound around the first magnetic core 11 as the first winding 114, primary side coils and secondary side coils of the transformers may be wound around the second magnetic core 12 as the second winding 124, and then the first magnetic core 11, the second magnetic core 12, and the third magnetic core 13 may be combined so that a closed magnetic circuit may be formed in the first magnetic core 11, the second magnetic core 12, and the third magnetic core 13 to obtain a magnetic assembly integrated by the inductors and the transformers. Alternatively, the lengths of the first magnetic core 11 and the second magnetic core 12 may be set to be different, so as to adapt to the different lengths of the coils arranged on the winding posts of the first magnetic core 11 and the second magnetic core 12.

In another alternative embodiment, as shown in FIG. 12, the magnetic assembly comprises a three-way magnetic assembly which includes three X-type magnetic cores and one I-type magnetic core, the three X-type magnetic cores including a fourth magnetic core 14, a fifth magnetic core 15 and a sixth magnetic core 16, and the one I-type magnetic core being a seventh magnetic core 17.

Wherein the fourth magnetic core 14, the fifth magnetic core 15 and the sixth magnetic core 16 are provided with a fourth winding, a fifth winding and a sixth winding, respectively.

The fourth magnetic core 14, the fifth magnetic core 15, the sixth magnetic core 16 and the seventh magnetic core 17 are sequentially arranged in an order of the fourth magnetic core 14, the fifth magnetic core 15, the sixth magnetic core 16 and the seventh magnetic core 17, or in an order of the fourth magnetic core 14, the seventh magnetic core 27, the fifth magnetic core 15 and the sixth magnetic core 16.

In one or more specific embodiments, the fourth magnetic core 14, the fifth magnetic core 15, the sixth magnetic core 16 and the seventh magnetic core 17 are sequentially arranged in an order of the fourth magnetic core 14, the fifth magnetic core 15, the sixth magnetic core 16 and the seventh magnetic core 17. Similarly to the two-way magnetic assembly, the magnetic flux in the closed magnetic circuit of the fourth magnetic core 14, the fifth magnetic core 15 and the sixth magnetic core 16 is partially canceled at the seventh magnetic core 17, and the partial cancellation of the magnetic flux can reduce the loss of the seventh magnetic core 17. Furthermore, on this basis, in the case where the loss of the seventh magnetic core 17 is reduced, the thickness of the seventh magnetic core 17 can be further reduced, so that the present application can use the seventh magnetic core 17 with a smaller size to form a closed magnetic circuit, reducing the volume of the magnetic assembly. Moreover, the fourth magnetic core 14, the fifth magnetic core 15 and the sixth magnetic core 16 include four side posts 102, so that the magnetic flux in the magnetic assembly is more dispersed, and the loss of the magnetic core can be reduced.

As can be seen from FIG. 12, two adjacent side posts 102 of the four side posts 102 of the fourth magnetic core 14, the fifth magnetic core 15 and the sixth magnetic core 16 form a strip-shaped gap, which can provide a heat dissipation channel along an extending direction of the side posts 102 for the magnetic assembly. The fourth magnetic core 14, the fifth magnetic core 15 and the sixth magnetic core 16 all include four side posts 102, thus four heat dissipation channels along the first direction in which the side posts 102 extend can be provided for the magnetic core, increasing the heat dissipation area. In addition, an annular gap exists between the winding post 101 and the side post 102 of the fourth magnetic core 14, the fifth magnetic core 15 and the sixth magnetic core 16, the annular gap communicates with the strip-shaped gap between two adjacent side posts 102, and jointly forming an annular heat dissipation channel in a second direction perpendicular to the extending direction of the side posts 102. Therefore, in this embodiment, the magnetic assembly has two main heat dissipation channels in a first direction and a second direction, which can better take away the heat generated inside the magnetic assembly and improve the heat dissipation effect, which solves the problem of poor heat dissipation after integration of a plurality of magnetic elements, and improves the service life and use safety of the magnetic assembly.

As an alternative embodiment, the side posts 102 of the fourth magnetic core 14, the fifth magnetic core 15 and the sixth magnetic core 16 may be arranged correspondingly, that is, on the same straight line. That is, four strip-shaped gaps of the fourth magnetic core 14, the fifth magnetic core 15 and the sixth magnetic core 16 respectively correspond one another, and communicate with the first direction heat dissipation channel of the fourth magnetic core 14, the fifth magnetic core 15 and the sixth magnetic core 16, so as to ensure smooth airflow and improve the heat dissipation effect.

As an alternative embodiment, the surfaces of the fourth magnetic core 14, the fifth magnetic core 15 and the sixth magnetic core 16 at the strip-shaped gaps are recessed inward to form grooves, so as to increase the flow area of the heat dissipation airflow and improve the heat dissipation effect.

As an alternative embodiment, the edge of the strip-shaped gap of the seventh magnetic core 17 corresponding to the fourth magnetic core 14, the fifth magnetic core 15 and the sixth magnetic core 16 may also be recessed inward to form a groove, so as to prevent the seventh magnetic core 17 from blocking the airflow, to ensure smooth airflow and improve the heat dissipation effect.

Of course, in other embodiments, the fourth magnetic core 14, the fifth magnetic core 15, the sixth magnetic core 16 and the seventh magnetic core 17 may also be sequentially arranged in an order of the fourth magnetic core 14, the seventh magnetic core 17, the fifth magnetic core 15 and the sixth magnetic core 16. In this embodiment, the connection surface 103 of the fourth magnetic core faces the outside of the magnetic assembly. That is, the connection surface 103 of the fourth magnetic core 14 is located on a side of the fourth magnetic core 14 facing away from the seventh magnetic core 17, and the unconnected ends of the four side posts 102 of the fourth magnetic core 14 are arranged in contact with the seventh magnetic core 17, thus the fourth magnetic core 14 and the seventh magnetic core 17 form a closed magnetic circuit. The seventh magnetic core 17 is disposed in contact with one side of the fifth magnetic core 15 where the four side posts 102 are not connected, to form a closed magnetic circuit with the fifth magnetic core 15. The connection surface 103 of the fifth magnetic core 15 is disposed in contact with the unconnected ends of the four side posts 102 of the sixth magnetic core 16, to form a closed magnetic circuit with the sixth magnetic core 16. Alternatively, the lengths of the first magnetic core 11 and the second magnetic core 12 may be set to be different, so as to adapt to the different lengths of the coils arranged on the winding posts of the fourth magnetic core 14, the fifth magnetic core 15, the sixth magnetic core 16 and the seventh magnetic core 17.

It should be noted that in this embodiment, the fourth magnetic core 14, the seventh magnetic core 17, the fifth magnetic core 15 and the sixth magnetic core 16 are arranged in this order from left to right, wherein the directions of “left” and “right” are relative, the technical solution corresponding to the embodiment in which the fourth magnetic core 14, the fifth magnetic core 15, the sixth magnetic core 16 and the seventh magnetic core 17 are arranged in this order from right to left should also be within the scope of protection of the present application.

In addition, the fourth magnetic core 14, the fifth magnetic core 15 and the sixth magnetic core 16 are all X-type magnetic cores, and the fourth magnetic core 14, the fifth magnetic core 15 and the sixth magnetic core 16 are illustrated as examples only, and the positions of the X-type magnetic cores of the fourth magnetic core 14, the fifth magnetic core 15 and the sixth magnetic core 16 may also be interchanged, and the technical solution corresponding to these embodiments should also be within the scope of protection of the present application.

In an alternative embodiment, the number of turns of at least one of the fourth winding, the fifth winding, and the sixth winding is equal.

It can be understood that the fourth winding, the fifth winding, and the sixth winding may have the same number of turns in order to make the three-way magnetic assembly have the same three-way magnetic performance, for example, to obtain three inductors having the same inductance value. Of course, in practical applications, those skilled in the art may determine the number of turns of the fourth winding, the fifth winding, and the sixth winding according to practical requirements, which is not limited by the present application.

In an alternative embodiment, the winding post 101 of at least one of the fourth magnetic core 14, the fifth magnetic core 15 and the sixth magnetic core 16 is formed with an air gap. Alternatively, the air gap consists of a plurality of air gaps.

It is to be understood that one or more segments of air gap may be formed on the winding posts 101 of the fourth magnetic core 14, the fifth magnetic core 15 and the sixth magnetic core 16 in order to avoid magnetic saturation and other undesirable phenomena. Of course, those skilled in the art can determine whether or not to provide one or more segments of air gap on the fourth magnetic core 14, the fifth magnetic core 15 and the sixth magnetic core 16 according to actual needs, and this application is not limited to these.

In an alternative embodiment, the winding posts 101 of the fourth magnetic core 14, the fifth magnetic core 15 and the sixth magnetic core 16 are formed with a fourth air gap, a fifth air gap and a sixth air gap, respectively, and the fourth air gap, the fifth air gap and the sixth air gap are equal in size.

It can be understood that, when it is necessary to form a fourth air gap, a fifth air gap and a sixth air gap on the winding posts 101 of fourth magnetic core 14, the fifth magnetic core 15 and the sixth magnetic core 16, respectively, in order to make the magnetic properties of the fourth magnetic core 14, the fifth magnetic core 15 and the sixth magnetic core 16 as identical as possible, alternatively the fourth air gap, the fifth air gap and the sixth air gap are set equal in size.

In an alternative embodiment, when direct current is input to the fourth winding, the fifth winding and the sixth winding respectively, the direct current magnetic fluxes formed in the winding posts 101 of the fourth magnetic core 14, the fifth magnetic core 15 and the sixth magnetic core 16 have the same direction.

When alternating current is input to the fourth winding, the fifth winding and the sixth winding respectively, the alternating current magnetic fluxes formed in the winding posts 101 of the fourth magnetic core 14, the fifth magnetic core 15 and the sixth magnetic core 16 have the same direction and the phases between them differ by 120 degrees.

In particular, in order to achieve at least partial cancellation of the magnetic flux formed on the seventh magnetic core 17 and in consideration of the difference between circuit structures applied by the three-way magnetic assembly, when current is input to the fourth winding, the fifth winding and the sixth winding, respectively, it is necessary to ensure that the magnetic fluxes formed by the direct current have the same direction, and the magnetic fluxes formed by the alternating current have the same direction, and the phases between them differ by 180 degrees.

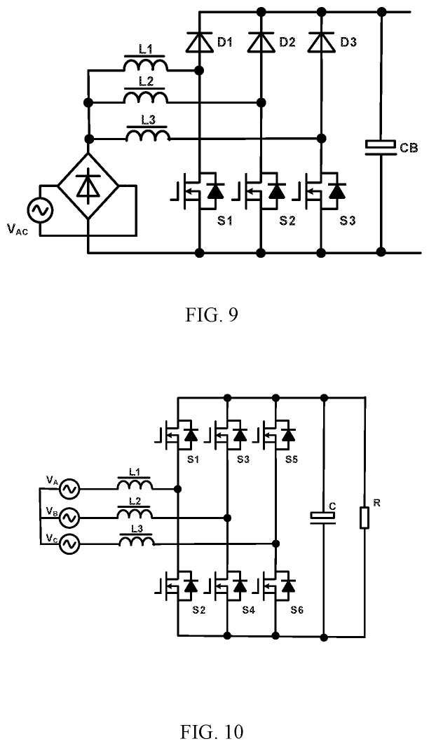

In a specific example, the three-way magnetic assembly is a three-way interleaved PFC (Power Factor Correction) inductor, the fourth winding includes a fourth coil, the fifth winding includes a fifth coil, and the sixth winding includes a sixth coil. That is, the three-way magnetic assembly can be used to make a magnetic assembly integrated by three inductors, for use in a three-way interleaved PFC circuit. As shown in FIG. 9, the three-way interleaved PFC circuit is a common technique in the field, and is not described herein.

In another specific example, the three-way magnetic assembly is a three-phase inductor, the fourth winding includes a seventh coil, the fifth winding includes an eighth coil, and the sixth winding includes a ninth coil. That is, the three-way magnetic assembly can be used to make another magnetic assembly integrated by three inductors, for use in the circuit as shown in FIG. 10, and the circuit is a common technique in the field, and is not described herein.

Specifically, the fourth coil may be wound around the fourth magnetic core 14 as the fourth winding, the fifth coil may be wound around the fifth magnetic core 15 as the fifth winding, and the sixth coil may be wound around the sixth magnetic core 16 as the sixth winding, and then the fourth magnetic core 14, the fifth magnetic core 15, the sixth magnetic core 16 and the seventh magnetic core 17 are combined so that a closed magnetic circuit may be formed in the fourth magnetic core 14, the fifth magnetic core 15, the sixth magnetic core 16 and the seventh magnetic core 17 to obtain a three-way inductor.

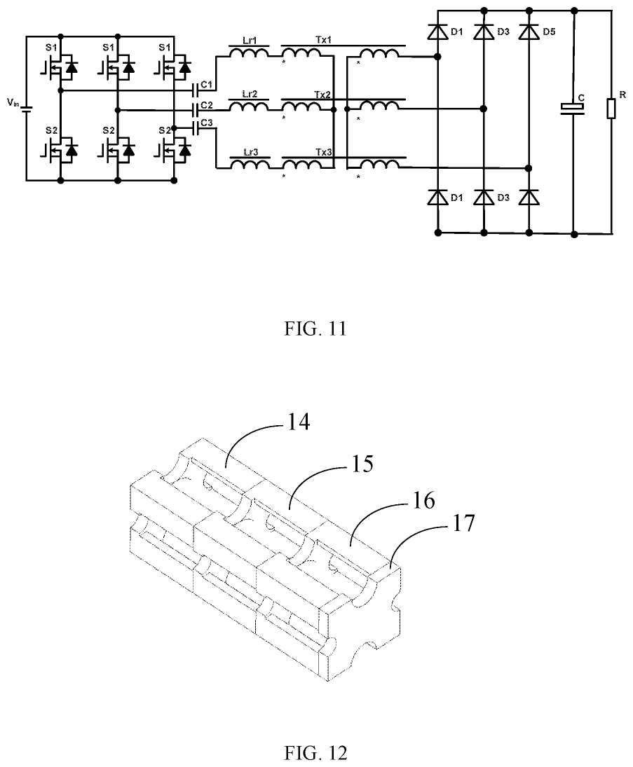

In another specific example, the three-way magnetic assembly is a three-phase transformer, the fourth winding includes a first primary side coil and a first secondary side coil, and the fifth winding includes a second primary side coil and a second secondary side coil, and the sixth winding includes a third primary side coil and a third secondary side coil. That is, the three-way magnetic assembly can be used to make a magnetic assembly integrated by three transformers, as shown in FIG. 11. Specifically, the first primary side coil and the first secondary side coil may be wound on the fourth magnetic core 14 as the fourth winding, and the second primary side coil and the second secondary side coil may be wound on the fifth magnetic core 15 as the fifth winding, the third primary side coil and the third secondary side coil are wound on the sixth magnetic core 16 as the sixth winding, and then the fourth magnetic core 14, the fifth magnetic core 15, the sixth magnetic core 16 and the seventh magnetic core 17 are combined so that a closed magnetic circuit may be formed in the fourth magnetic core 14, the fifth magnetic core 15, the sixth magnetic core 16 and the seventh magnetic core 17 to obtain a three-way transformer.

Based on the same principle, this embodiment further discloses a power module. The power module includes the magnetic assembly as described in this embodiment.

Specifically, as shown in FIGS. 7 to 11, the power module may include the magnetic assembly of this embodiment, and may also include devices such as a capacitor, a switching element and the like, wherein the magnetic assembly may provide an inductor, a transformer, and a magnetic device in which the inductor and the transformer are integrated, such as a three-phase inductor, a three-phase transformer, and etc.

As an alternative embodiment, the power module may be disposed on a module circuit board, and the module circuit board may be disposed on a main circuit board to form a switching power supply.

Since the power module solves the problem in accordance with the principle similar to the method described above, the implementation of the power module may be found by referring to the implementation of the method, and is not repeated herein.

Based on the same principle, this embodiment further discloses a switching power supply. The switching power supply includes a power module as described in this embodiment.

It can be appreciated that the switching power supply may include a main circuit board on which a power module may be provided. Alternatively, the power module may be first disposed on the module circuit board, and then the module circuit board is disposed on the main circuit board to form the switching power supply, so that the power module of this embodiment is disposed in the switching power supply.

Since the switching power supply solves the problem in accordance with the principle similar to the method described above, the implementation of the switching power supply may be found by referring to the implementation of the method, and is not repeated herein.

Based on the same principle, this embodiment further discloses a method of fabricating a magnetic assembly. The method comprising:

a step S100: providing windings on winding posts of at least two X-type magnetic cores, wherein the X-type magnetic core includes a winding post 101 and four side posts 102 surrounding the winding post 101, and one side of each of the four side posts 102 is respectively connected with one side of the winding post 101 to form a connection surface 103;

a step S200: causing the other sides of the four side posts 102 and the winding posts 101 of the X-type magnetic cores to be respectively arranged in contact with the connection surface 103 of the I-type magnetic core or other X-type magnetic cores, such that the at least two X-type magnetic cores and the at least one I-type magnetic core are connected to form a closed magnetic circuit.

Since the method solves the problem in accordance with the principle similar to the magnetic assembly described above, the implementation of the method may be found by referring to the implementation of the magnetic assembly, and is not repeated herein.

The various embodiments in the specification are described in a progressive manner, and the same or similar parts between the various embodiments may be referred to each other, and each embodiment focuses on the differences from the other embodiments. In particular, the system embodiment is simply described since it is substantially similar to the method embodiment, and please refer to the description of the method embodiment for the relevant content.

The above descriptions are only embodiments of the present application and are not intended to limit the application. Various changes and modifications can be made to the present application by those skilled in the art. Any modifications, equivalents, improvements, etc. made within the spirit and scope of the present application are intended to be included within the scope of the claims of the present application.

What is claimed is:

1. A magnetic assembly, characterized in comprising at least two X-type magnetic cores and at least one I-type magnetic core;
a winding is arranged on the X-type magnetic core, and the at least two X-type magnetic cores and the at least one I-type magnetic core form a closed magnetic circuit;
the X-type magnetic core includes a winding post and four side posts surrounding the winding post, and one side of each of the four side posts is respectively connected with one side of the winding post to form a connection surface;
the other sides of the four side posts and the winding post are respectively arranged in contact with the connection surface of the I-type magnetic core or other X-type magnetic cores.

2. The magnetic assembly according to claim 1, characterized in that, the magnetic assembly comprises a two-way magnetic assembly which includes two X-type magnetic cores and one I-type magnetic core, the two X-type magnetic cores including a first magnetic core and a second magnetic core, and the one I-type magnetic core being a third magnetic core;
the first magnetic core and the second magnetic core are provided with a first winding and a second winding, respectively;
the first magnetic core, the second magnetic core, and the third magnetic core are sequentially arranged in an order of the first magnetic core, the third magnetic core, and the second magnetic core, or in an order of the first magnetic core, the second magnetic core, and the third magnetic core.

3. The magnetic assembly according to claim 2, characterized in that, the winding posts of the first magnetic core and/or the second magnetic core are formed with air gaps.

4. The magnetic assembly according to claim 3, characterized in that, the air gap consists of a plurality of air gaps.

5. The magnetic assembly according to claim 3, characterized in that, the winding posts of the first magnetic core and the second magnetic core are formed with a first air gap and a second air gap, respectively, and the first air gap and the second air gap are equal in size.

6. The magnetic assembly according to claim 2, characterized in that, when direct current is input to the first winding and the second winding respectively, the direct current magnetic fluxes formed in the winding post of the first magnetic core and the winding post of the second magnetic core have the same direction;
when alternating current is input to the first winding and the second winding respectively, the alternating current magnetic fluxes formed in the winding post of the first magnetic core and the winding post of the second magnetic core have the same direction and the phases between them differ by 180 degrees.

7. The magnetic assembly according to claim 2, characterized in that, the two-way magnetic assembly is a two-way inductor, the first winding includes a first coil, and the second winding includes a second coil.

8. The magnetic assembly according to claim 2, characterized in that, the two-way magnetic assembly comprises an inductor and a transformer, the first winding includes an inductive coil of the inductor and the second winding includes a primary side coil and a secondary side coil of the transformer.

9. The magnetic assembly according to claim 1, characterized in that, the magnetic assembly comprises a three-way magnetic assembly which includes three X-type magnetic cores and one I-type magnetic core, the three X-type magnetic cores including a fourth magnetic core, a fifth magnetic core and a sixth magnetic core, and the one I-type magnetic core being a seventh magnetic core;
the fourth magnetic core, the fifth magnetic core and the sixth magnetic core are provided with a fourth winding, a fifth winding and a sixth winding, respectively;
the fourth magnetic core, the fifth magnetic core, the sixth magnetic core and the seventh magnetic core are sequentially arranged in an order of the fourth magnetic core, the fifth magnetic core, the sixth magnetic core and the seventh magnetic core, or in an order of the fourth magnetic core, the seventh magnetic core, the fifth magnetic core and the sixth magnetic core.

10. The magnetic assembly according to claim 9, characterized in that, the winding post of at least one of the fourth magnetic core, the fifth magnetic core and the sixth magnetic core is formed with an air gap.

11. The magnetic assembly according to claim 10, characterized in that, the winding posts of the fourth magnetic core, the fifth magnetic core and the sixth magnetic core are formed with a fourth air gap, a fifth air gap and a sixth air gap, respectively, and the fourth air gap, the fifth air gap and the sixth air gap are equal in size.

12. The magnetic assembly according to claim 9, characterized in that, when direct current is input to the fourth winding, the fifth winding and the sixth winding respectively, the direct current magnetic fluxes formed in the winding posts of the fourth magnetic core, the fifth magnetic core and the sixth magnetic core have the same direction;
when alternating current is input to the fourth winding, the fifth winding and the sixth winding respectively, the alternating current magnetic fluxes formed in the winding posts of the fourth magnetic core, the fifth magnetic core and the sixth magnetic core have the same direction and the phases between them differ by 120 degrees.

13. The magnetic assembly according to claim 9, characterized in that, the three-way magnetic assembly is a three-way inductor, the fourth winding includes a fourth coil, the fifth winding includes a fifth coil, and the sixth winding includes a sixth coil.

14. The magnetic assembly according to claim 10, characterized in that, the three-way magnetic assembly is a three-phase inductor, the fourth winding includes a seventh coil, the fifth winding includes an eighth coil, and the sixth winding includes a ninth coil.

15. The magnetic assembly according to claim 9, characterized in that, the three-way magnetic assembly is a three-phase transformer, the fourth winding includes a first primary side coil and a first secondary side coil, and the fifth winding includes a second primary side coil and a second secondary side coil, and the sixth winding includes a third primary side coil and a third secondary side coil.

16. A power module, characterized in comprising a magnetic assembly according to claim 1.

17. A switching power supply, characterized in comprising a power module according to claim 16.
